(19) United States
(12) Patent Application Publication
(10) Pub. No.: US 2006/0051026 A1
(43) Pub. Date: Mar. 9, 2006

(54) Multilayer microstructural device

(76) Inventors: Fredrik Nikolajeff, Stockholm (SE); Olle Larsson, Stockholm (SE); Sverker Hard Af Segerstad, Goteborg (SE); Anna-Lena Hard af Segerstad Boberg, Goteborg (SE); Thomas Ericson, Hagersten (SE)

Correspondence Address: MORRISON & FOERSTER LLP, 425 MARKET STREET, SAN FRANCISCO, CA, 94105-2482, US

(21) Appl. No.: 10/519,333

(22) PCT Filed: Jun. 27, 2003
(86) PCT No.: PCT/SE03/01135

§ 371 Date: Jun. 23, 2005

(30) Foreign Application Priority Data
Jul. 4, 2002 (SE) 0202092-3

(51) Int. Cl. G02B 6/30

(52) U.S. Cl. 385/49; 385/52

(57) ABSTRACT

Multilayer microstructural device comprising a first and a second layer, which layers are aligned relative to each other by mating alignment structures. The first layer is a positive replication of a microstructural master comprising a number of microstructural elements, the second layer is a negative replication of the same microstructural master, and each pair of mating alignment structures originate from the same microstructural element on the master.

### THE FIELD OF THE INVENTION

The present invention relates to a multilayer microstructural device and in particular to a multilayer microstructural device comprising mating alignment structures.

### BACKGROUND OF THE INVENTION

Optical fibers provide key elements not only for modern telecommunication systems. In order to couple light into and out from fibers, highly efficient fiber/waveguide connectors need to be developed.

Optical fibers have since many years been used in long-haul distance information transportation, e.g. in the optical backbone network between major cities. As the distance between transmitters and receivers is shortened, the need for low-cost waveguide connectors increases. For instance, in Fiber-to-the-Home (FTTH) applications a device connecting one or several optical fibers with the end user can be compared to consumer products such as telephone jacks and plugs. Other applications include any interface between optical fibers and components for receiving or transmitting signals.

Several types of waveguide connections fabricated with etched silicon chips as substrate/carrier have been reported. Silicon chips, however, are expensive to produce and are liable to break under the high pressures which they will be subjected to when pressing waveguide connections.

In order to enable fiberoptic connectors to be used on a large scale, micromachined connectors must be able to compete strongly with existing solutions, especially with regard to cost.

Fortunately, almost all microstructures that are possible to produce technically in e.g. silicon or glass substrates can also be replicated in thermoplastic materials. Since replication in itself is not an expensive process, there is an economic leeway which will enable the use of advanced micro-electro-mechanical system (MEMS) manufacturing equipment, e.g. photolithography, electron beam lithography, wet and dry plasma etching processes, etc.

In contrast to silicon, thermoplastic materials have good dielectric properties. The thermoplastic material may also be transparent, if desired, which can be beneficial in the case of integrated optics. Further, thermoplastics constitute a cheaper raw material than silicon.

Replicated polymeric substrates can be used in the construction of fiberoptic transmitter/receiver modules having microstructures such as fiber-aligning grooves, optofibers and semiconductor components such as PIN diodes, LEDs, Vertical-cavity surface-emitting lasers (VCSELs), amplifiers, drive electronics, integrated circuits and so on. The substrate may also contain integrated functional elements or parts thereof, such as micro optical surfaces for advanced beam shaping of the light being coupled, such as diffractive optical elements (DOEs), which can be designed to harness light in a desired manner.

By utilizing micro machining techniques, miniaturized connectors can be manufactured and replication technology can then be used to produce low-cost devices in plastic materials.

To achieve desired mechanical or optical features one or more replicated elements are often bonded on top of each other forming a layered structure. The different layers then may have different functions. For example U.S. Pat. No. 5,984,534 discloses a double layer microstructural device comprising a first layer with V-grooves for accommodating optical fibers and a second layer acting as a lid and retainer for the optical fibers.

It is frequently of great importance that the layers in a multilayer micro structural device are aligned with high precision relative to each other. Alignment can either be obtained by formation of alignment structures in facing surfaces of successive layers or by an active aligning step in the assembly procedure. However, it is difficult to achieve a high degree of alignment precision using existing alignment structures, why additional active alignment often is required, and active alignment is time consuming and therefore expensive.

### SUMMARY OF THE INVENTION

The object of the invention is to provide a new multilayer microstructural device, which overcomes the drawbacks of the prior art multilayer microstructural devices. This is achieved by the multilayer microstructural device as defined in claim 1. A process for the manufacture of this device is defined in claim 6. Preferred embodiments of the invention are defined in the dependent claims. The attached claims are hereby incorporated by reference.

One advantage with the multilayer micro structural device is that improved aligning accuracy is achieved by mating alignment structures, eliminating the need for active alignment to achieve high precision aligning.

Another advantage is that the process for manufacturing the multilayer microstructural device is a low cost process. Yet another advantage is that the process according to the present invention is highly suitable for large volume production.

Still another advantage is that both layers in a double layer microstructural device are produced from one single master.

Further problems, their solutions and the associated advantages will be evident from the description and examples.

### BRIEF DESCRIPTION OF THE DRAWINGS

The invention will be described in detail below with reference to the drawings, in which:

FIG. 1 shows a schematic cross section of a multilayer microstructural device according to the present invention.

FIG. 2a shows a top view of a master layout for producing a multilayer micro structural device according to an embodiment of the present invention.

FIG. 2b shows a cross sectional view along A-A of a positive replication of the master layout of FIG. 2a.

FIG. 2c shows a cross sectional view along A-A of a negative replication of the master layout of FIG. 2a.

FIG. 3 shows a detail of an intermediate product according to an embodiment of the invention.

### DETAILED DESCRIPTION OF PREFERRED EMBODIMENTS

Generally, the multilayer microstructural device according to the present invention comprises at least a first and a second micro-replicated layer. The layers may be formed by injection molding of a polymeric material such as a thermoplastic material or the like. However, other methods of producing micro-replicated layers may also be used, such as replication using UV-curable polymers and the like.

To obtain the desired mechanical or optical features the layers are aligned relative to each other by mating alignment structures. To achieve a high degree of alignment precision, the layers are formed such that the first layer is a positive replication of a microstructural master, the second layer is a negative replication of the same micro structural master, and that each pair of mating alignment structures originates from the same microstructural element on the master.

The features of the multilayer microstructural device according to the present invention will now be is described more in detail in the form of an optofiber waveguide connection, but it should be understood that the multilayer microstructural device according to the invention can be adapted to numerous situations where high precision alignment of two or more layers in a multilayer microstructural device is required.

Examples of such devices are any connectors where a functional element has to be connected to and aligned with a signal conductor such as an optical fiber, an electrically conductive wire or the like, a channel or capillary. Such devices may form a component for computer or telecommunication applications, as well as a biochip or part thereof, a micro fluidic structure, a micro mechanical structure, a micro-electro-mechanical structure, an opto-electronic structure, an opto-mechanical structure, an optic structure, or combinations thereof. Such devices may also as such constitute a biochip, a micro fluidic structure, a micro mechanical structure, a micro-electro-mechanical structure, an optic structure, or a combination thereof.

The functional element is any functional element interacting with the signal or material entering or leaving via the signal conductor. Examples of functional elements include micro-optical structures, such as diffractive or refractive structures, e.g. diffractive optical elements, lenses such as collimating Fresnel lenses, off-axis diffractive lenses, or fan-out elements. Further examples of functional elements are elements which interact physically, chemically, or biochemically with either the signal from the conductor, or with the environment or a sample brought in contact with the element, emitting a signal which is led through the conductor. Chemical, physical and biochemical sensors are examples of such elements. These can be manufactured on the surface using known techniques, e.g. techniques for depositing or immobilizing the desired substances on the surface. In this context, the term “substance” is to be understood very widely, including inorganic substances and compounds, such as metals and inert or reactive inorganic compounds, as well as organic and biological compounds, including biological matter such as peptides, proteins, macromolecules, organelles, cells and microorganisms.

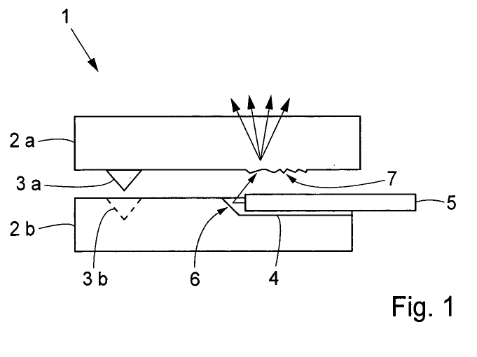

FIG. 1 shows a schematic cross section of a fiber connector 1 comprised of a first or upper layer 2a and a second or lower layer 2b. The fiber connector 1 further comprises alignment structures 3a, 3b formed in the first and second layer 2a and 2b respectively. A V-groove 4 is formed in the second layer 2b and is adapted to hold an optical fiber 5 in place. The V-groove 4 has a sloped end-facet 6 in that is used to reflect light from the optical fiber 5 onto a functional element, here a micro-optical surface 7, e.g. a transmissive diffractive element, formed in the first layer 2a.

The connector could for instance be used in a dense wavelength-division multiplexing (DWDM) system, where different wavelengths transported through the fiber could be split to reach different receivers. For symmetry reasons the opposite case, where light from different transmitters are coupled into the same optical fiber 5, can just as well be realized.

It is understood that the term fiber alignment groove while used in singular, also encompasses its plural forms. According to one embodiment of the invention, the device is adapted to receive ribbon fibers, and/or a multitude of fibers. In array applications, a device according to the invention may have a multitude of fiber alignment grooves, each fiber being aligned relative to one or more functional elements, preferably to one functional element.

Further, relating to the fiber alignment groove, it is in many applications suitable to provide a lip or shoulder in either the upper or the lower, preferably in the upper part, of the device in order to ensure that the fiber becomes properly aligned also with respect to its length axis, or in other words, inserted properly in relation to the end-facet 6 and in relation to the functional element, e.g. the micro-optical surface 7. This is not shown in the figures. Preferably this lip or shoulder is either so small, or so oriented, that it does not interfere with the transmission and/or reflection of light from the optic fiber, or with the signal, in the case of the optic fiber being replaced by other signal conductor.

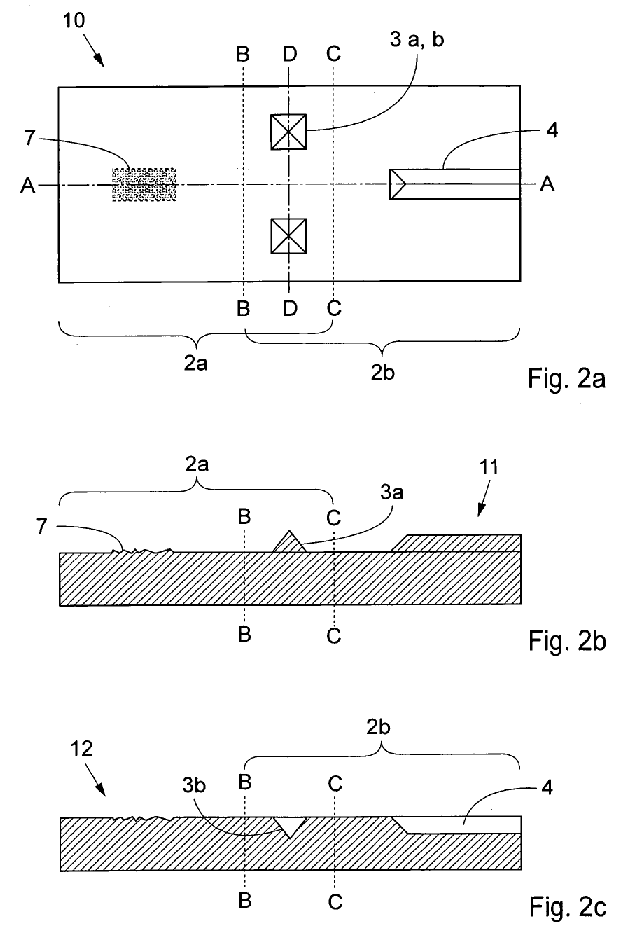

As mentioned above, the improved alignment that is obtained according to the invention rely on that the alignment structures 3a and 3b of the first and the second layer 2a, and 2b respectively originate from the same structure on one single master 10. FIG. 2a shows the master-layout 10 by which this is achieved. FIG. 2a is a top view of the master-layout 10 of the connector 1. FIG. 2c is a cross sectional view of FIG. 2a along A-A. As can be seen from the figures, all structures in the master 10 are negative (concave), whereas FIG. 2b shows a positive (convex) replication 11 of the master.

As is shown in FIG. 2b, the first layer 2a in the connector 1 is represented by the section to the left of C-C in the positive replication 11 of the master 10. As is shown in FIG. 2c, the second layer 2b in the connector 1 is represented by the section to the right of B-B in the negative replication 12 of the master. Hence, when the two layers 2a and 2b are put together, the mating alignment structures 3a and 3b originate from the same structure on the master 10, whereby they will fit perfectly into each other. This high level of accuracy cannot be achieved when the structures originate from two individual masters, as it is very difficult to produces two masters with the required identity of features and dimensions.

As is clear from FIGS. 2b and 2c, the layer 2a has to be rotated relative an axis of rotation D-D in FIG. 2a before it is fitted on top of the layer 2b. Due to this rotation the shape of the mating alignment structures 3a and 3b is restricted to structures that are symmetric about a central mirror plane with a normal parallel with A-A in FIG. 2a.

According to one embodiment of the invention, the device 1 is manufactured according the following process:

First a master 10 in the form of a silicon wafer 10 is produced. The master 10 comprises a large number of sections representing the layers 2a and 2b of the connector 1. The number of layer sections on each master wafer 10 is determined of the size of each connector layer 2a and 2b. Each connector layer section 2a and 2b is formed in the master wafer 10 by the following steps:
a) Formation of the micro-optical surface 7 in the silicon wafer 10, crystal plane (10), by direct-write electron-beam lithography in a photo resist layer applied on the surface of the silicon wafer 10, followed by plasma dry etching. Hence, the surface relief of the functional element, here a micro-optical surface 7, is transferred into the surface of the silicon wafer 10. The micro-optical surface 7 may be of several different types, such as a collimating Fresnel lens, an off-axis diffractive lens or a fan-out element.
b) Deposition of a silicon nitride layer onto the wafer 10.
c) Formation of the V-grooves 4 and alignment microstructures 3a and 3b by photolithography followed by nitride plasma etching and wet etching of the silicon in KOH.
d) Stripping of the remaining nitride by wet etching.

Hence, one and the same master 10 comprises both deep structures 3a, 3b and 4 for later fiber alignment and self-alignment of the double layer structure as well a functional element, here a micro optical surface 7 for beam steering, all aligned relative each other with the available accuracy of the lithography steps.

Thereafter, two copies of the structured silicon master 10 are created by a electroplating process in metall, e.g. nickel, a first copy with the same polarity as the master 10 (having concave structures) and a second copy with opposite polarity (containing convex structures). The process of making master copies by electroplating is well known in the art of micro replication and will therefore not be described in detail herein.

The two metall copies are hereafter used as mould surfaces for injection molding (or any other molding process such as e.g. embossing or casting) of first and second thermoplastic discs (or any other molded material such as thermoset or UV curable resins). The second plastic disc has the same polarity as the master 10 (having concave structures) representing the second layer 2b in the connector 1. Hence the first plastic disc has opposite polarity, (containing convex structures) representing the first layer 2a in the connector 1.

The molded discs are thereafter diced into connector layer sections 2a and 2b. Then the second connector layer sections 2b which are intended to reflect light from the optical fiber towards the micro-optical surface are metallised according to procedures well known to a person skilled in the art.

Finally, the first connector layer sections 2a are arranged on top of the corresponding second connector layer sections 2b, with optical fibers placed in the V-grooves, and bonded together.

As the connector layer sections 2a, and 2b comprises mating alignment structures 3a, 3b that originates from the same structures on the master 10 the alignment precision will be in the order of the precision in the lithography steps.

The obtainable alignment precision has been evaluated using connector layer sections 2a and 2b put together without on additional alignment than the mating alignment structures. A microscope was used to measure the resulting alignment accuracy for a number of connectors 1 and the measurements showed that the obtainable aligning accuracy was slightly lower (about ±5 μm) than the alignment precision of the lithography steps which in this case was roughly estimated to ±2 μm.

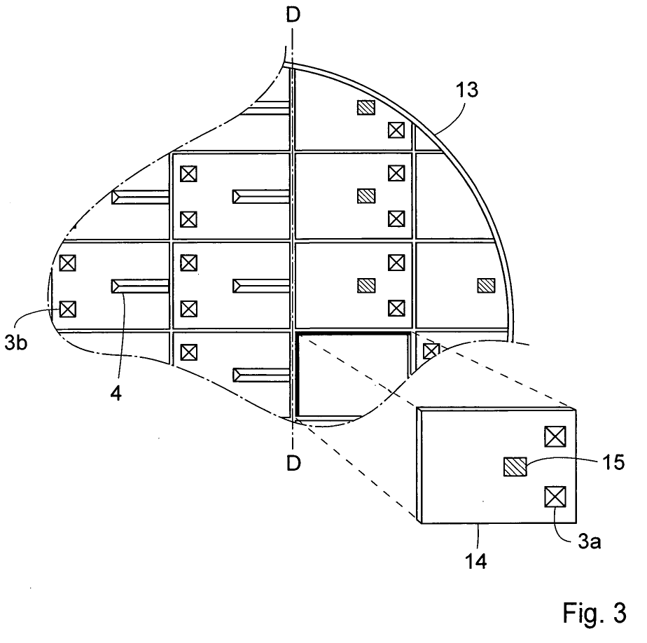

Another embodiment is illustrated in FIG. 3 which shows schematically a section of a molded plastic disc 13 carrying both the positive and the negative imprints of one single master. A connector layer section 14 is shown, excised from the disc, and having the previously described alignment structure 3a and a functional element 15 on its surface. The disc has a line of symmetry indicated as D-D and on the left side in FIG. 3, the opposite connector layer sections can be seen, carrying the opposite alignment structure 3b and the fiber engaging V-groove 4.

Although the invention has been described with regard to its preferred embodiments, which constitute the best mode presently known to the inventors, it should be understood that various changes and modifications as would be obvious to one having the ordinary skill in this art may be made without departing from the scope of the invention which is set forth in the claims appended hereto.

1. Multilayer microstructural device (1) comprising a first and a second layer (2a, 2b), which layers are aligned relative to each other by mating alignment structures (3a, 3b), characterized in that
the first layer (2a) is a positive replication of a microstructural master (10);
the second layer (2b) is a negative replication of the same microstructural master (10); and
that each pair of mating alignment structures (3a, 3b) originate from the same microstructural element (3a, 3b) on the master (10).

2. Multilayer microstructural device (1) according to claim 1, wherein the positive or the negative replication comprises microstructural elements other than the alignment structures.

3. Multilayer microstructural device (1) according to claim 1 or 2, wherein the microstructural master (10) comprises at least one deep microscale structure (3a, 3b, 4) and at least one shallow surface relief (7), which are aligned relative to each other by said mating alignment structures (3a, 3b).

4. Multilayer microstructural device (1) according to claim 3, wherein the deep microscale structure is a fiber aligning groove (4).

5. Multilayer microstructural device (1) according to claim 3, wherein the shallow surface relief is chosen among structures forming at least a part of a functional element chosen among a micro optical structure, a diffractive structure (7), a microfluidic structure, the substrate structure for the immobilization of compounds or particles, a microelectronic circuit, a micro mechanical structure or combinations thereof.

6. Process for the production of a multilayer microstructural device comprising a first and a second layer, said layers comprising at least one functional element and a structure for aligning a signal conductor in relation to said functional element (-s), which layers can be aligned relative to each other by mating alignment structures, comprising the following steps:
a) production of a master, comprising a large number of sections representing said first and second layers of said device;
b) formation of the desired functional elements and alignment microstructures, so that the master comprises both the structures for alignment of the layers, the signal conductor, as well as the functional element, aligned relative eachother with the available accuracy of the lithography step;
c) production of two copies of said master, the first copy having the same polarity as the master and the second copy having the opposite polarity;
d) production of first and second plastic discs, said discs carrying both layers of the multilayer device having alignment structures originating from the same master; and
e) dicing the discs into individual first and second layers of the multilayer device.

7. The process according to claim 6, wherein the silicon master is produced using lithographical methods, such as electron-beam lithography and/or photolithography.

8. The process according to claim 6, wherein the copies of step c are created by electroplating in metal.

9. The process according to claim 6, wherein the plastic discs of step d are created by injection moulding, or any other molding process, using the copies of step c as mould surfaces.

10. An intermediate product of the process according to claim 6, consiting of a thermoplastic disc carrying at lease one layer of a multilayer device having alignment structures originating from the same master.

11. A multilayer device obtainable through the process according to any one of claims 6-10.

12. A multilayer device having alignment structures originating from the same master and exhibiting an alignment accuracy of at least about ±5 μm.
